(19) United States
(12) Patent Application Publication
(10) Pub. No.: US 2018/0031684 A1
(43) Pub. Date: Feb. 1, 2018

(54) INFORMATION PROCESSING APPARATUS INCLUDING SUBSTRATE ON WHICH VIBRATION COMPONENT THAT OUTPUTS SOUND WAVE THROUGH VIBRATION IS MOUNTED

(71) Applicant: CANON KABUSHIKI KAISHA, Tokyo (JP)

(72) Inventors: Yusuke Horishita, Nagareyama-shi (JP); Junnosuke Yokoyama, Toride-shi (JP); Manabu Hada, Kawasaki-shi (JP); Michio Fukushima, Yokohama-shi (JP)

(21) Appl. No.: 15/648,241

(22) Filed: Jul. 12, 2017

(30) Foreign Application Priority Data
Jul. 29, 2016 (JP) 2016-150104

(51) Int. Cl. G01S 7/521; G01S 15/04; G10K 11/35; H04N 1/00; G10K 11/00

(52) U.S. Cl. CPC G01S 7/521; H04N 1/00896; H04N 1/00352; G10K 11/002; G10K 11/35; G01S 15/04; H04N 2201/0094

(57) ABSTRACT

An MFP includes a substrate on which an ultrasonic sensor that outputs a sound wave through vibration is mounted, a horn in a tubular shape configured to limit an output direction of the sound wave output from the ultrasonic sensor, and a buffer member provided between a surface of the substrate on a side on which the ultrasonic sensor is provided and an opening on one side of the horn.

### BACKGROUND OF THE INVENTION

### Field of the Invention

The disclosure relates to an attaching structure of a substrate on which a vibration component that outputs a sound wave through vibration is mounted and a horn that limits an output direction of the sound wave.

### Description of the Related Art

Japanese Unexamined Patent Application Publication (Translation of PCT Application) No. 2009-545143 discusses a printed circuit board on which a surface mounted ceramic capacitor that vibrates due to a piezoelectric effect is mounted.

In Japanese Unexamined Patent Application Publication (Translation of PCT Application) No. 2009-545143, however, a horn that limits the output direction of a sound wave output from the surface mounted ceramic capacitor is not discussed at all. A horn needs to be attached to limit the output direction of a sound wave output from a vibration component mounted on a substrate. For the reasons of dimensional constraints and the like of the vibration component, it is difficult to directly attach a horn to the vibration component mounted on a surface of the substrate. Thus, attaching the horn to the substrate on which the vibration component is mounted can be considered.

When the horn is attached to the substrate, it is necessary to prevent a sound wave output from the vibration component from leaking out from between the horn and the substrate. If the horn is brought into direct contact with the substrate to prevent a sound wave from leaking out from between the horn and the substrate, however, vibration of the vibration component is transmitted to the horn via the substrate.

### SUMMARY OF THE INVENTION

The disclosure is directed to an information processing apparatus capable of inhibiting a sound wave output from a vibration component from leaking out from between a substrate and a horn and also inhibiting vibration of the vibration component from transmitting to the horn via the substrate.

According to an aspect of the disclosure, an information processing apparatus includes a substrate on which a vibration component that outputs a sound wave through vibration is mounted, a horn in a tubular shape configured to limit an output direction of the sound wave output from the vibration component, and a first buffer member provided between a surface of the substrate on a side on which the vibration component is provided and an opening on one side of the horn.

Further features and aspects of the disclosure will become apparent from the following description of various example embodiments with reference to the attached drawings.

### BRIEF DESCRIPTION OF THE DRAWINGS

FIG. 1 is a block diagram of a multifunction peripheral (MFP).

FIG. 2 is a detailed block diagram of the MFP.

FIG. 3 is a view illustrating a detection area of an ultrasonic sensor.

FIG. 4 is a perspective view of a human sensor unit.

FIG. 5 is a block diagram illustrating devices mounted on a substrate.

FIG. 6 is a view illustrating the human sensor unit before a horn is mounted and the human sensor unit after the horn is mounted.

FIGS. 7A to 7C are views illustrating a sectional view and the like of the human sensor unit.

FIG. 8 is a plan view illustrating a substrate on which the ultrasonic sensor is mounted.

FIGS. 9A to 9D are views illustrating a detailed structure of the horn.

FIGS. 10A and 10B are views illustrating a buffer member attached to the horn.

FIGS. 11A and 11B are sectional views of the human sensor unit.

FIG. 12 is a diagram illustrating a case where a user approaches the MFP from the front thereof.

FIG. 13 is a diagram illustrating a case where the user approaches the MFP from the side thereof.

FIG. 14 is a diagram illustrating a case where a passerby passes in front of the MFP.

FIG. 15 is a flowchart illustrating a return algorithm based on a detection result by the ultrasonic sensor.

### DESCRIPTION OF THE EXAMPLE EMBODIMENTS

Hereinafter, a mode for carrying out the disclosure will be described using the drawings. A mode in which the disclosure is applied to a multifunction peripheral (MFP) having a plurality of functions such as scanning, printing, and copying will be described below.

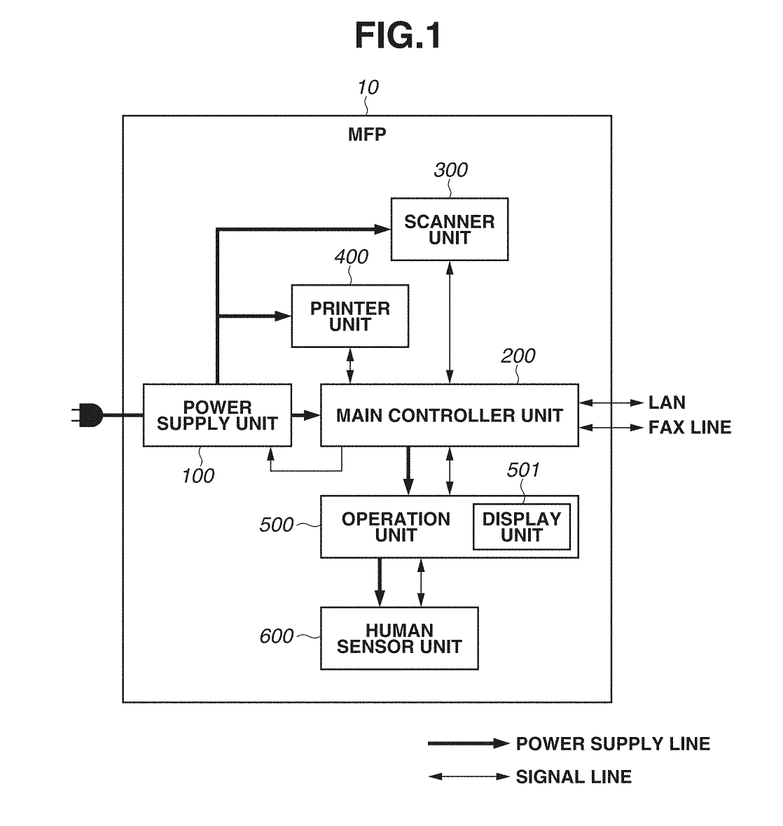

FIG. 1 is a schematic block diagram of an MFP.

The MFP 10 includes a power supply unit 100, a main controller unit 200, a scanner unit (reading unit) 300, a printer unit (printing unit) 400, an operation unit 500, and a human sensor unit 600. The MFP 10 has at least two power modes. The MFP 10 has a standby mode in which functions such as scanning, printing, and copying can be executed and a sleep mode in which less power is consumed than in the standby mode. The standby mode is an S0 state and the sleep mode is an S3 state specified by the Advanced Configuration and Power Interface (ACPI) standard.

The MFP 10 transfers from the standby mode to the sleep mode when transfer conditions for the sleep mode are satisfied. Specifically, the MFP 10 transfers from the standby mode to the sleep mode after the passage of a predetermined time without the operation unit 500 being operated by a user. The transfer conditions for the sleep mode are not limited to the above passage of the predetermined time and may be a user's operation of a power-saving button provided on the operation unit 500, that a preset sleep transfer time has come, or the passage of a predetermined time without a print process or a scan process being performed.

In the sleep mode, the supply of power to the main controller unit 200, the scanner unit 300, the printer unit 400, and the operation unit 500 is limited. Also in the sleep mode, a display unit 501 of the operation unit 500 is turned off. In the standby mode, the display unit 501 of the operation unit 500 is turned on. Power is supplied to the main controller unit 200, the scanner unit 300, the printer unit 400, and the operation unit 500 in the standby mode.

In the sleep mode, power is supplied to the human sensor unit 600. In the sleep mode, the MFP 10 transfers from the sleep mode to the standby mode based on a detection result by the human sensor unit 600.

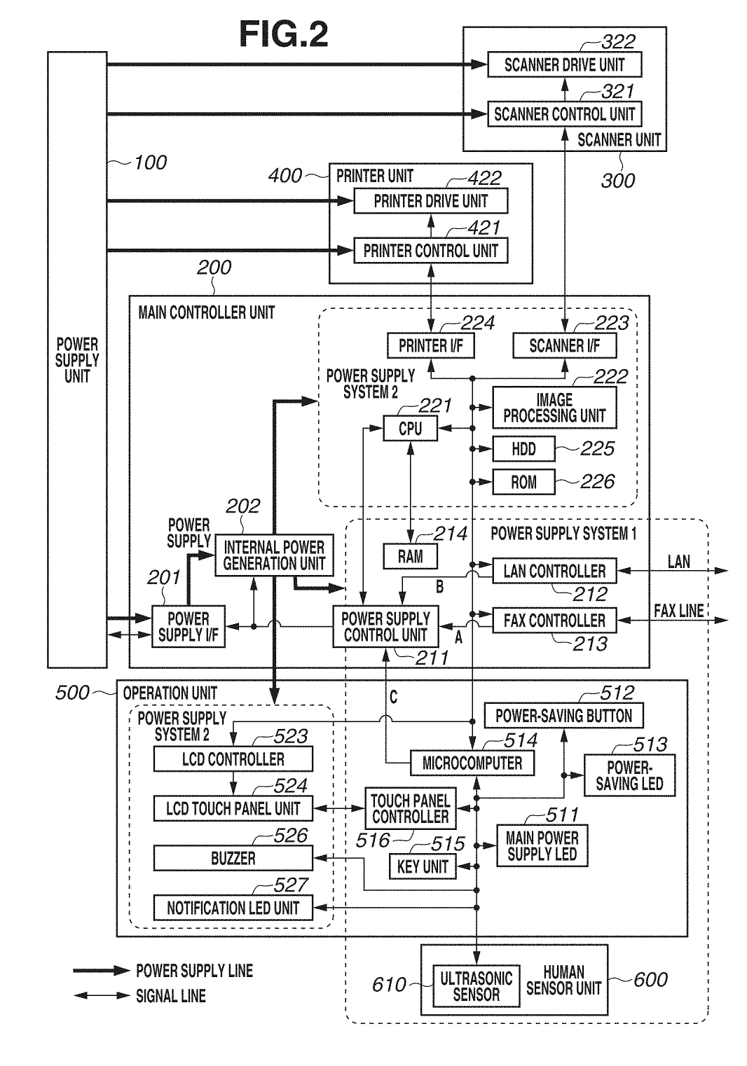

FIG. 2 is a detailed block diagram of the MFP.

The scanner unit 300 optically reads an image of a document to generate image data. The scanner unit 300 includes a scanner control unit 321 and a scanner drive unit 322. The scanner drive unit 322 includes a drive unit to move a reading head that reads an image of a document, and a drive unit to convey the document to a reading position. The scanner control unit 321 controls the operation of the scanner drive unit 322. When a scan process is performed, the scanner control unit 321 receives setting information set by the user through communication with the main controller unit 200 and controls the operation of the scanner drive unit 322 based on the received setting information.

The printer unit 400 forms an image on a recording medium (sheet) according to the electrophotographic method. The printer unit 400 includes a printer control unit 421 and a printer drive unit 422. The printer drive unit 422 includes a motor that rotates a photosensitive drum (not illustrated), a mechanism portion to press a fixing apparatus, and a heater. The printer control unit 421 controls the operation of the printer drive unit 422. When a print process is performed, the printer control unit 421 receives setting information set by the user through communication with the main controller unit 200 and controls the operation of the printer drive unit 422 based on the received setting information.

The main controller unit 200 controls the operation of the scanner unit 300 and the printer unit 400. For example, the main controller unit 200 causes the scanner unit 300 to read an image of a document to generate image data according to a copying instruction input into the operation unit 500. Then, the main controller unit 200 performs image processing on the generated image data and outputs the processed image data to the printer unit 400. Then, the main controller unit 200 causes the printer unit 400 to print the image.

The main controller unit 200 includes at least two power supply systems, i.e., a power supply system 1 to which devices that need to operate also in the sleep mode belong and a power supply system 2 to which devices that do not need to operate in the sleep mode belong. An internal power generation unit 202 that receives the supply of power from the power supply unit 100 via a power supply interface (I/F) 201 feeds power to the devices in the power supply system 1 in the sleep mode. In the sleep mode, power is not supplied to the devices in the power supply system 2.

The supply of power to the devices in the power supply system 2 may only be limited in the sleep mode, instead of being stopped. Also in the sleep mode, the devices in the power supply system 2 may be clock-gated or the clock frequency may be lowered. The devices in the power supply system 1 include a power supply control unit 211, a local area network (LAN) controller 212, a facsimile (FAX) controller 213, and a random access memory (RAM) 214. Even when the MFP 10 is in the sleep mode, power is supplied to the FAX controller 213 and the LAN controller 212 in the sleep mode so that the controllers can return to the standby mode in response to FAX reception or a print request from a network.

The internal power generation unit 202 feeds power to the devices in the power supply system 2 in the standby mode. The devices in the power supply system 2 include a central processing unit (CPU) 221, an image processing unit 222, a scanner I/F 223, a printer I/F 224, a hard disk drive (HDD) 225, and a read only memory (ROM) 226. The supply of power to the devices in the power supply system 2 is stopped in the sleep mode.

The power supply control unit 211 is a device that controls the power mode of the MFP 10. The power supply control unit 211 may be configured as a processor that executes software or as a logic circuit. Interrupt signals A, B, and C are input into the power supply control unit 211. If one of the interrupt signals A, B, and C is input into the power supply control unit 211 in the sleep mode, the power supply control unit 211 controls the internal power generation unit 202 to supply power to the devices in the power supply system 2. The MFP 10 is thereby returned from the sleep mode to the standby mode.

The interrupt signal A is a signal output by the FAX controller 213. The FAX controller 213 outputs the interrupt signal A in response to FAX reception from a FAX line. The interrupt signal B is a signal output by the LAN controller 212. The LAN controller 212 outputs the interrupt signal B in response to reception of a print job packet or a status confirmation packet from a LAN. The interrupt signal C is a signal output by a microcomputer 514 of the operation unit 500. The microcomputer 514 outputs the interrupt signal C when the microcomputer 514 determines that a user of the MFP 10 is present based on a detection result by the human sensor unit 600 or a power-saving button 512 is pressed.

The CPU 221 to which power is supplied in response to input of one of the interrupt signals A to C returns the MFP 10 to the state before transferring to the sleep mode. Specifically, the CPU 221 reads information indicating the state of the MFP 10 from the RAM 214 performing a self-refresh operation in the sleep mode. Then, the CPU 221 uses the read information to return the MFP 10 to the state before transferring to the sleep mode. Then, the CPU 221 performs processing corresponding to a return factor of the interrupt signals A to C.

The operation unit 500 includes a liquid crystal display (LCD) touch panel unit 524 (display unit 501) in which an LCD panel and a touch panel are integrated, a key unit 515 that detects a user's key operation of the numeric keypad, the start key or the like, and a buzzer 526. An image corresponding to image data generated by the CPU 221 of the main controller unit 200 is drawn in the LCD touch panel unit 524. An LCD controller 523 receives image data from the CPU 221 and displays an image in the LCD touch panel unit 524 based on the image data. If the user touches the screen of the LCD touch panel unit 524, a touch panel controller 516 analyzes coordinate data of the touched position and notifies the microcomputer 514 of the coordinate data. The microcomputer 514 notifies the CPU 221 of the coordinate data. The microcomputer 514 may notify the CPU 221 of, instead of the coordinate data, information indicating a touched icon or the like. The microcomputer 514 periodically scans the operation of the key unit 515. Then, when the microcomputer 514 determines that the user has operated the key unit 515, the microcomputer 514 notifies the CPU 221 of information about the key unit 515 that has been operated. When notified of a user's operation on the LCD touch panel unit 524 or the key unit 515, the CPU 221 operates the MFP 10 according to the user's operation.

The operation unit 500 includes a plurality of light-emitting diodes (LEDs). A main power supply LED 511 lights up when the main power supply of the MFP 10 is turned on. A notification LED unit 527 is controlled to light up by the microcomputer 514 and notifies the user of the status of the MFP 10 such as execution of a job or the occurrence of an error.

The operation unit 500 includes, similarly to the main controller unit 200, at least two power supply systems, i.e., the power supply system 1 to which devices that need to operate also in the sleep mode belong and the power supply system 2 to which devices that do not need to operate in the sleep mode belong. The devices in the power supply system 1 include the microcomputer 514, the main power supply LED 511, the power-saving button 512, a power-saving LED 513, the touch panel controller 516, and the key unit 515. The devices in the power supply system 2 include the LCD controller 523, the LCD touch panel unit 524, the buzzer 526, and the notification LED unit 527. Power is supplied to the power-saving button 512 and the power-saving LED 513 that lights up the power-saving button 512 even in the sleep mode so that the MFP 10 in the sleep mode can return from the sleep mode to the standby mode following a user's operation on the power-saving button 512.

The human sensor unit 600 is a device in the power supply system 1 and operates to detect a user of the MFP 10 in the sleep mode. The human sensor unit 600 includes an ultrasonic sensor 610. The microcomputer 514 determines whether a user of the MFP 10 is present by periodically reading and analyzing a detection result by the ultrasonic sensor 610. The ultrasonic sensor 610 in the present example embodiment is a sensor that outputs and receives an ultrasonic wave by one chip. The ultrasonic sensor 610 may have a chip for oscillation that outputs an ultrasonic wave and a chip for reception that receives an ultrasonic wave separately. The ultrasonic sensor (vibration component) 610 in the present example embodiment outputs an ultrasonic wave by vibrating a piezoelectric element arranged inside the ultrasonic sensor 610 and also outputs an electric signal (voltage value) corresponding to the vibration received by the piezoelectric element.

In the present example embodiment, an example of using the ultrasonic sensor 610 will be described, but the sensor may not be an ultrasonic sensor. Instead of the ultrasonic sensor, for example, a pyroelectric sensor or an infrared sensor may be used.

The microcomputer 514 outputs an oscillation signal to the ultrasonic sensor 610 for a fixed time. As a result, the piezoelectric element of the ultrasonic sensor 610 vibrates to output an ultrasonic wave of about 40 KHz in an inaudible region for a fixed time. Then, the microcomputer 514 determines whether a user of the MFP 10 is present based on a detection result of the ultrasonic wave received by the ultrasonic sensor 610. The microcomputer 514 outputs the interrupt signal C to the power supply control unit 211 based on the determination that a user of the MFP 10 is present. When the interrupt signal C is input, the power supply control unit 211 controls the power supply unit 100 to return the power mode of the MFP 10 from the sleep mode to the standby mode. In the present example embodiment, an example of supplying power from the internal power generation unit 202 to the human sensor unit 600 has been described, but power may be supplied to the human sensor unit 600 directly by the power supply unit 100.

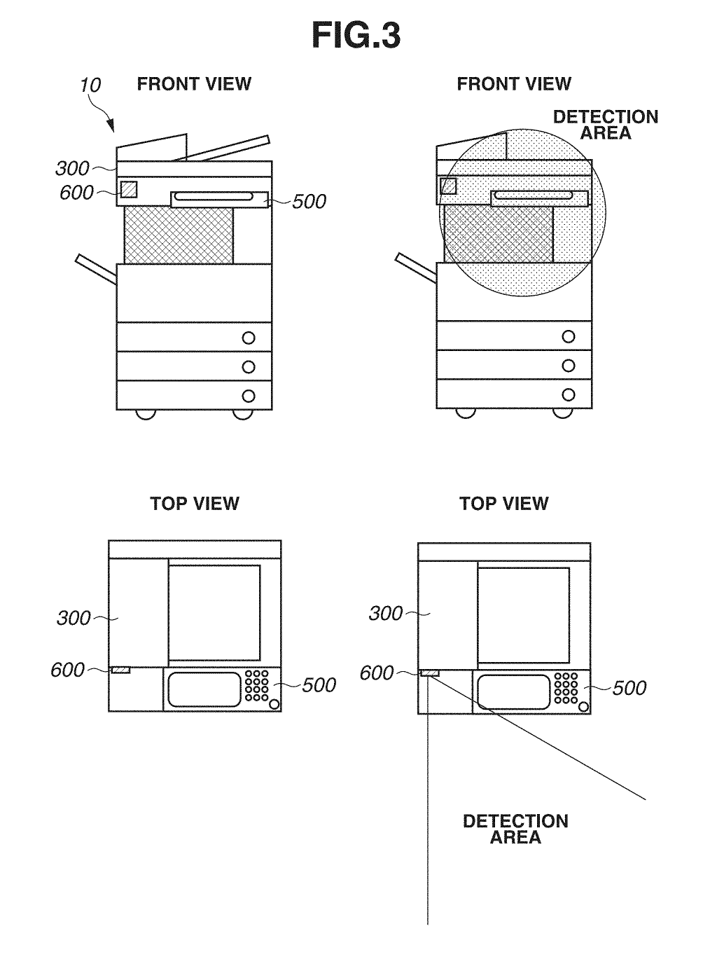

FIG. 3 is a view illustrating a detection area of an ultrasonic sensor.

The ultrasonic sensor 610 in the present example embodiment outputs an ultrasonic wave to receive an ultrasonic wave reflected by an object such as a human being (hereinafter, called a reflected wave when appropriate). The distance to a human being or an object can be estimated based on time from the output of an ultrasonic wave to reception of a reflected wave. In the present example embodiment, the microcomputer 514 calculates the distance to a human being or an object based on a detection result by the ultrasonic sensor 610.

The ultrasonic sensor 610 is installed such that the detection area of the ultrasonic sensor 610 is the front of, or slightly downward of, the MFP 10. The detection area is a range up to about 2 m from the MFP 10. The installation location of the human sensor unit 600 is the front side of the scanner unit 300 and the opposite side of the operation unit 500 when the MFP 10 is viewed from the front side. The human sensor unit 600 is arranged by being inclined toward the operation unit 500 so that the user standing in front of the operation unit 500 can be detected.

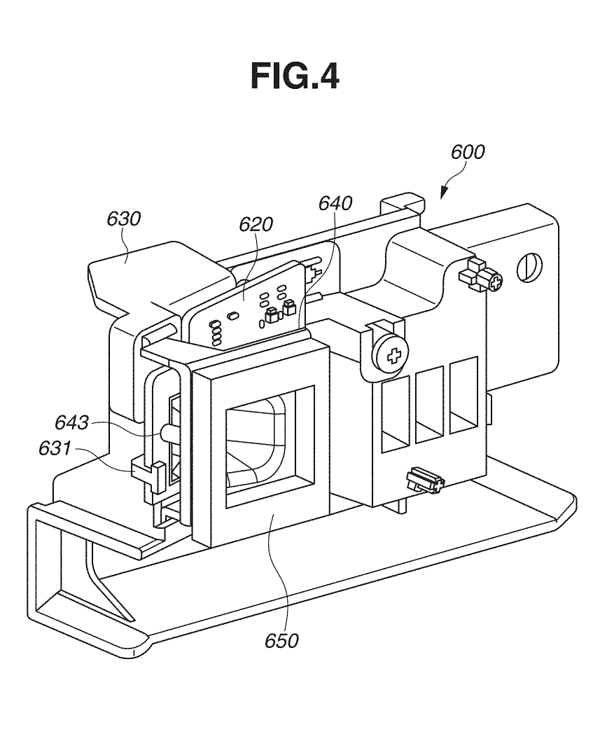

FIG. 4 is a perspective view of the human sensor unit.

The human sensor unit 600 includes a substrate 620 on which the ultrasonic sensor 610 is mounted, a pedestal (fixing member) 630 that fixes the substrate 620, a horn 640 to control directivity of an ultrasonic wave output from the ultrasonic sensor 610, and a buffer member (sponge) 650. The ultrasonic sensor 610 is a surface mount device (SMD) type ultrasonic sensor and is mounted on a surface of the substrate 620. The ultrasonic sensor 610 has a piezoelectric element that outputs an ultrasonic wave according to an applied voltage and also outputs an electric signal corresponding to the received ultrasonic wave.

The pedestal 630 is a member to arrange the substrate 620 on which the ultrasonic sensor 610 is mounted such that the substrate 620 is inclined toward the operation unit 500.

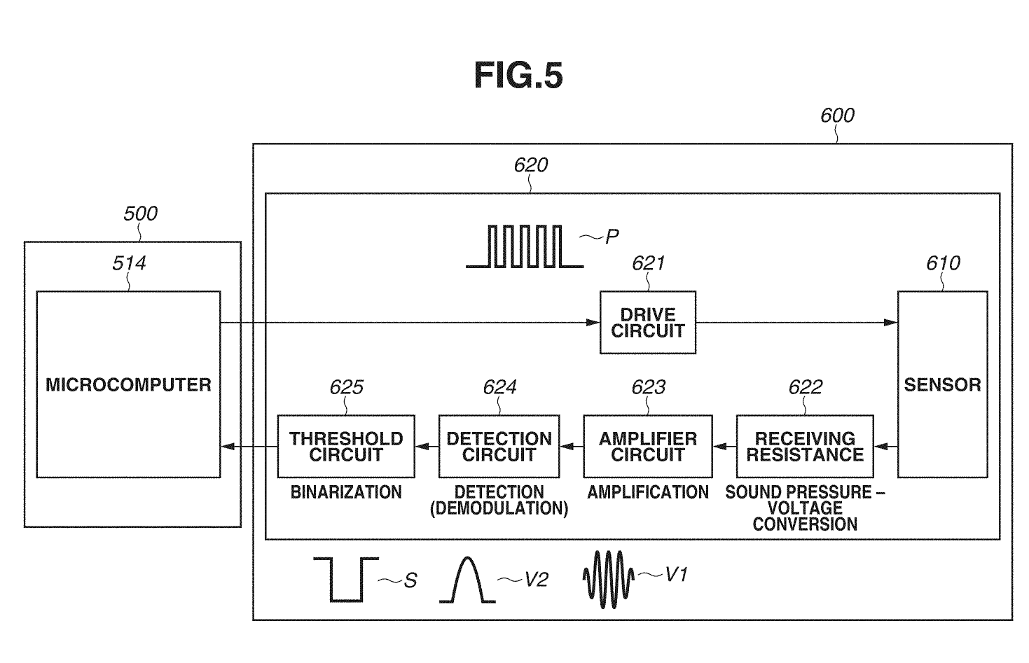

FIG. 5 is a block diagram illustrating devices mounted on the substrate.

The substrate 620 is a two-layer glass epoxy substrate. As illustrated in FIG. 5, the ultrasonic sensor 610, a drive circuit 621, a receiving resistance 622, an amplifier circuit 623, a detection circuit 624, and a threshold circuit 625 are mounted on the substrate 620. The drive circuit 621 vibrates the piezoelectric element of the ultrasonic sensor 610 in response to reception of a drive pulse P output by the CPU 221. The receiving resistance 622 converts a sound pressure of the ultrasonic wave received by the ultrasonic sensor 610 into a voltage. The amplifier circuit 623 amplifies the converted voltage. A waveform V1 of the voltage amplified by the amplifier circuit 623 is demodulated by the detection circuit 624. Then, a signal V2 output from the detection circuit 624 is compared with a voltage level set to the threshold circuit 625. Then, an analog signal S is output from the threshold circuit 625 to the microcomputer 514. The substrate 620 is arranged by being inclined toward the operation unit 500 by about 15 degrees relative to the front of the MFP 10. However, the angle of the substrate 620 is not limited to about 15 degrees described above and is adjusted based on the positional relationship between the operation unit 500 and the human sensor unit 600. Specifically, the angle decreases with a decrease in the distance between the operation unit 500 and the human sensor unit 600, and the angle increases with an increase in the distance therebetween.

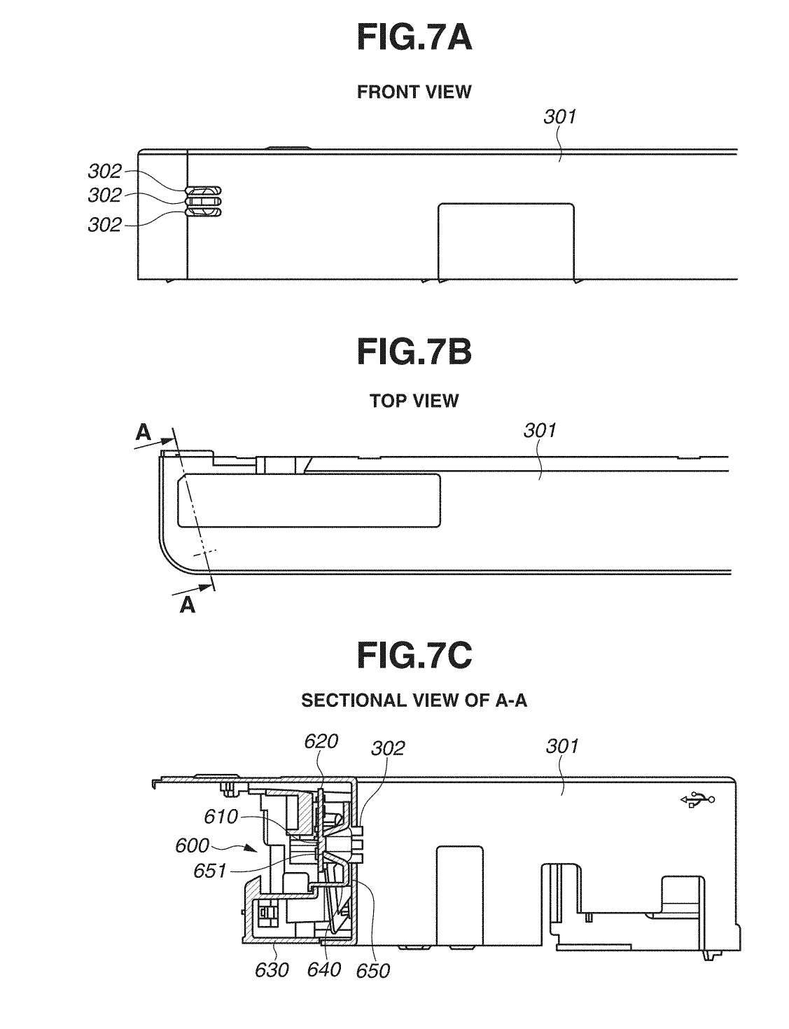

The horn 640 is a tubular member to limit the output direction of an ultrasonic wave so that the ultrasonic wave output from the ultrasonic sensor 610 is not diffused. Without the horn 640, it is difficult to limit the detection range. An opening 644 of the horn 640 on the side of a cover member 301 (FIG. 7) (the other side) has a rectangular shape of about 13 mm× about 13 mm and has a conic shape in which the size of the opening 644 decreases toward the ultrasonic sensor 610. However, opening dimensions of the opening 644 of the horn 640 are not limited to the above dimensions.

The buffer member 650 is arranged between the opening 644 on the other side of the horn 640 and the cover member 301 (FIG. 7) described below. The buffer member 650 fills a gap between the horn 640 and the cover member 301 so that an ultrasonic wave should not leak out from the gap between the horn 640 and the cover member 301.

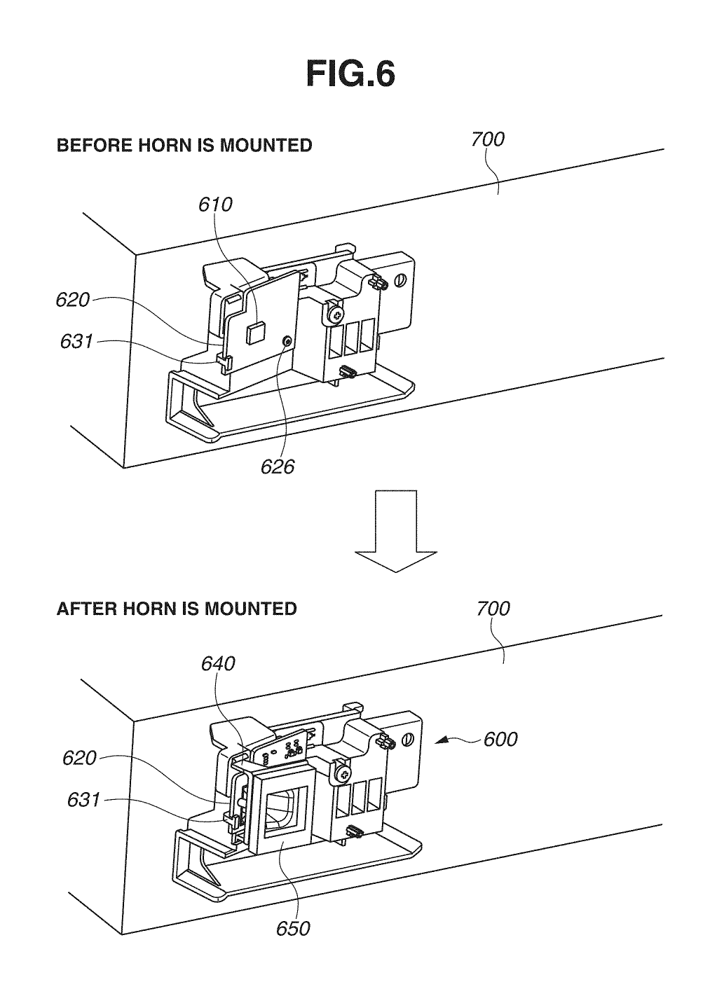

FIG. 6 is a view illustrating the human sensor unit before the horn is mounted and the human sensor unit after the horn is mounted.

The human sensor unit 600 is fixed to a frame plate (fixing member) 700 provided inside the scanner unit 300. The substrate 620 is fixed to the pedestal 630 by a screw 626.

The horn 640 is arranged on the side of the substrate 620 on which the ultrasonic sensor 610 is mounted. The horn 640 is fixed to the pedestal 630. The buffer member 650 is attached to an end of the horn 640 on the side of the cover member 301. The buffer member 650 is arranged between the horn 640 and the cover member 301 to fill the gap between the horn 640 and the cover member 301. Accordingly, an ultrasonic wave output from the ultrasonic sensor 610 can be inhibited from leaking out from the gap between the horn 640 and the cover member 301. The buffer member 650 is a sponge and thus can inhibit propagation of vibration of the horn 640 to the cover member 301.

FIGS. 7A to 7C are views illustrating a sectional view and the like of the human sensor unit. FIG. 7A is a front view of a portion of the scanner unit where the human sensor is provided. FIG. 7B is a top view of the portion of the scanner unit where the human sensor is provided. FIG. 7C is a sectional view taken along line A-A in FIG. 7B.

If the human sensor unit 600 is arranged in a place where the user can touch, the ultrasonic sensor 610 or the substrate 620 may malfunction due to contact of the user's finger or the like with the ultrasonic sensor 610 or the substrate 620. Thus, as illustrated in FIG. 7A, the human sensor unit 600 is covered with the cover member 301 of the scanner unit 300. A plurality of slits 302 is provided in the cover member 301 to output an ultrasonic wave output from the ultrasonic sensor 610 to the outside or to receive a reflected wave of an ultrasonic wave reflected outside. Each of the slits 302 has a hole shape stretching in the horizontal direction. In the present example embodiment, three slits are arranged along the vertical direction. The length in the horizontal direction (horizontal width) of the slit 302 is larger than the opening dimension of the horn 640 in the horizontal direction.

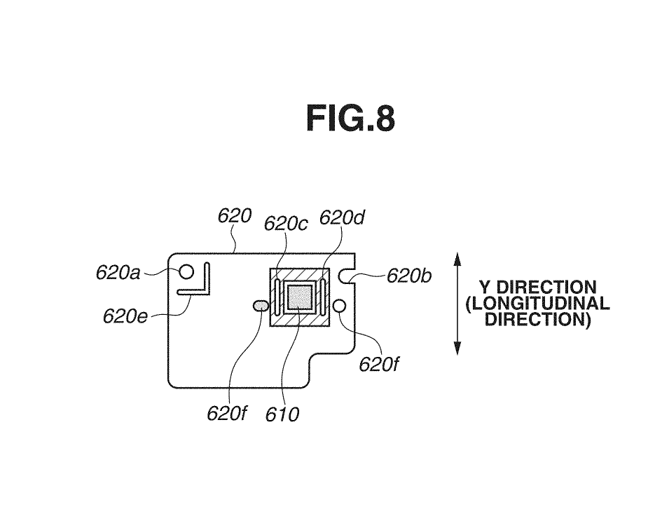

FIG. 8 is a plan view illustrating the substrate on which the ultrasonic sensor is mounted.

The ultrasonic sensor 610 is mounted on the substrate 620. The drive circuit 621, the receiving resistance 622, the amplifier circuit 623, the detection circuit 624, and the threshold circuit 625 are mounted on the substrate 620, but are omitted in FIG. 8. The substrate 620 has a screw hole 620a formed to allow the screw 626 to pass therethrough to fix the substrate 620 to the pedestal 630. That is, the portion of the substrate 620 where the screw hole 620a is formed becomes a contact portion between the pedestal 630 and the substrate 620. The screw 626 is fixed to the pedestal 630 via the screw hole 620a. Also, a notched portion 620b on which a claw portion 631 formed in the pedestal 630 is hooked is formed at an end of the substrate 620 on the opposite side of the screw hole 620a.

Also, slits 620c and 620d are formed in the substrate 620 around the ultrasonic sensor 610. The slit 620c is formed in the substrate 620 between the ultrasonic sensor 610 and the screw hole 620a. The slit 620d is formed in the substrate 620 between the ultrasonic sensor 610 and the notched portion 620b. The length of the slit 620c in the longitudinal direction (Y direction in FIG. 8) is longer than the length of the ultrasonic sensor 610 in the longitudinal direction. Also, the length of the slit 620d in the longitudinal direction is longer than the length of the ultrasonic sensor 610 in the longitudinal direction.

A slit 620e in an L shape is formed in the substrate 620 between the ultrasonic sensor 610 and the screw hole 620a. The slit 620e is formed to surround the screw hole 620a. Like the slit 620c, the slit 620e is formed in the substrate 620 between the ultrasonic sensor 610 and the screw hole 620a.

By forming the slits 620c, 620d, and 620e in the substrate 620, vibration of the ultrasonic sensor 610 can be prevented from propagating from the screw 626 or the claw portion to other members (the frame plate 700 and the pedestal 630). If it is necessary to electrically connect the substrate 620 and the frame plate 700 or the like, the screw 626 made of metal is adopted. If, however, it is not necessary to electrically connect the substrate 620 and the frame plate 700 or the like, the screw 626 made of plastic or the like may be adopted. When the screw 626 made of plastic is adopted, it is possible to suppress the propagation of vibration of the ultrasonic sensor 610 to other members via the screw 626.

Furthermore, the substrate 620 in the present example embodiment has a boss hole 620f that allows a boss 643 provided in the horn 640 to pass therethrough. The relative position of the horn 640 relative to the ultrasonic sensor 610 can be determined with high precision by the boss 643 of the horn 640 being inserted into the boss hole 620f. A buffer member 651 is brought into contact with an area represented by oblique lines in FIG. 8. The buffer member 651 comes into contact with an area of the substrate 620 where the slits 620c and 620d are formed.

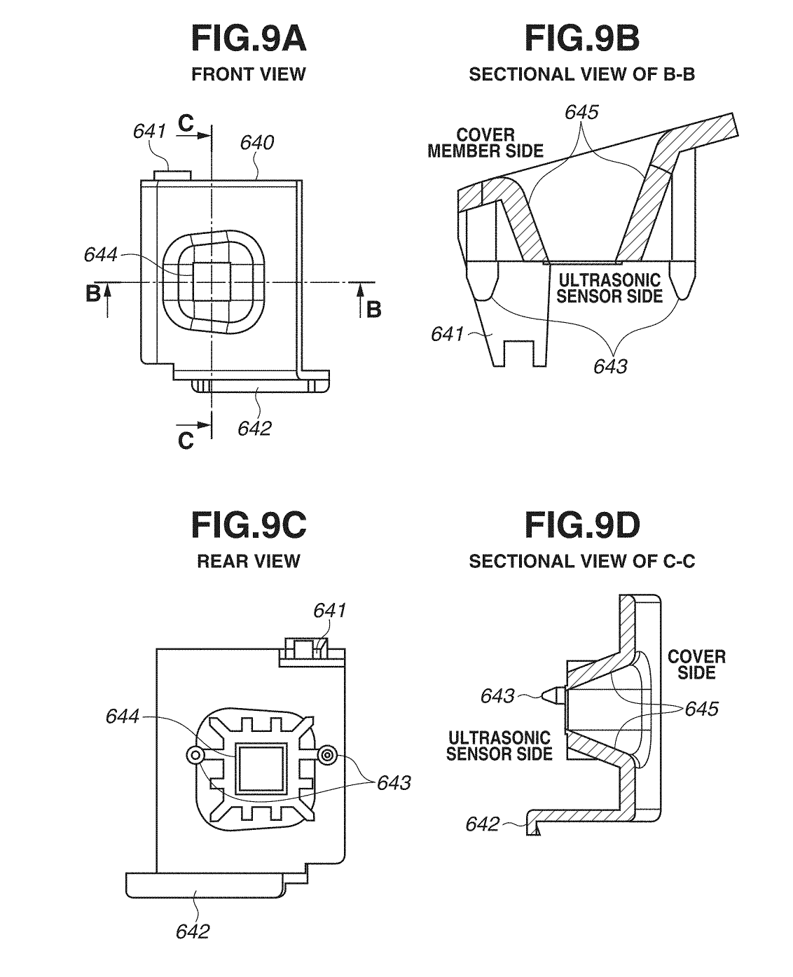

FIGS. 9A to 9D are views illustrating a detailed structure of the horn. FIG. 9A is a front view of the horn. FIG. 9B is a sectional view taken along line B-B in FIG. 9A. FIG. 9C is a rear view of the horn. FIG. 9D is a sectional view taken along line C-C in FIG. 9A.

The horn 640 is a member that controls directivity of an ultrasonic wave sent from the ultrasonic sensor 610 mounted on the substrate 620. As illustrated in FIGS. 9A and 9D, the horn 640 has a conic shape in which the opening size decreases toward the ultrasonic sensor 610. An inner surface 645 of the horn 640 in the present example embodiment is configured as a plurality of planes, but may also be configured as curved surfaces. The horn 640 is provided with hook portions 641 and 642 to fix the horn 640 to the pedestal 630. The horn 640 is fixed to the pedestal 630 without being fixed to the substrate 620. By fixing the horn 640 to the pedestal 630, vibration of the ultrasonic sensor 610 is inhibited from propagating to the horn 640. As long as the vibration to the horn 640 can sufficiently be inhibited by the slits 620c, 620d, and 620e provided in the substrate 620, the horn 640 may be fixed to the substrate 620.

Also, as illustrated in FIGS. 9B and 9C, the horn 640 has two bosses 643 formed to determine the position of the horn 640 relative to the ultrasonic sensor 610. It is better to arrange the horn 640 close to the ultrasonic sensor 610 so that an ultrasonic wave output from the ultrasonic sensor 610 is output with directivity. If, however, the horn 640 is fixed to the substrate 620 on which the ultrasonic sensor 610 is mounted, vibration of the ultrasonic sensor 610 propagates to the horn 640. Also, vibration of the ultrasonic sensor 610 is inhibited by the horn 640.

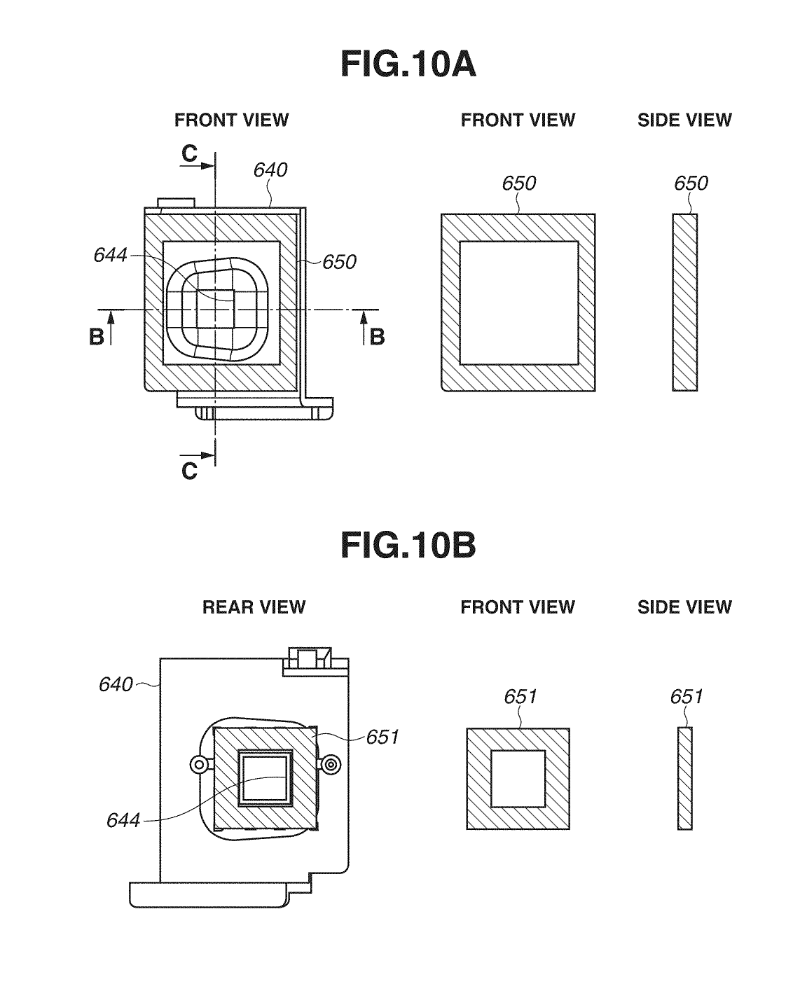

FIGS. 10A and 10B are views illustrating a buffer member attached to the horn. FIG. 10A is a view illustrating the buffer member attached to the horn on the side of the cover member. FIG. 10B is a view illustrating the buffer member attached to the horn on the side of the substrate.

As illustrated in FIG. 10A, the buffer member 650 is arranged between the horn 640 and the cover member 301. The buffer member 650 is a sponge. Also, the buffer member 650 is annular and has an opening larger than the opening 644 of the horn 640 on the side of the cover member 301 (the other side).

As illustrated in FIG. 10B, the buffer member 651 is arranged between the opening 644 of the horn 640 on the side of the substrate 620 (one side) and the substrate 620. The buffer member 651 is, like the buffer member 650, a sponge. Also, the buffer member 651 is annular and has an opening larger than the opening 644 of the horn 640 on the side of the substrate 620 (one side).

The buffer member 650 and the buffer member 651 are desirably made of a raw material of high sound absorbing properties and sound insulating properties. As a raw material superior in sound absorbing properties, for example, a porous material having a rough surface and a large number of bubble shapes inside such as glass wool, rock wool, and soft urethane foam is desirably adopted for the buffer members 650 and 651. Furthermore, as a raw material superior in sound insulating properties, a flexible raw material such as sponge and rubber having a small stress when compressed and conforming well with irregularities of an adherend can be adopted for the buffer members 650 and 651.

A raw material of high vibration-proof properties and vibration control properties is more desirable for the buffer member 650 and the buffer member 651. As a raw material superior in vibration-proof properties and vibration control properties, for example, an elastic damping material such as rubber and sponge can be adopted for the buffer member 650 and the buffer member 651.

In the present example embodiment, EPTSEALER manufactured by Nitto Denko Corporation or CALMFLEX manufactured by Inoac Corporation is adopted for the buffer members 650 and 651.

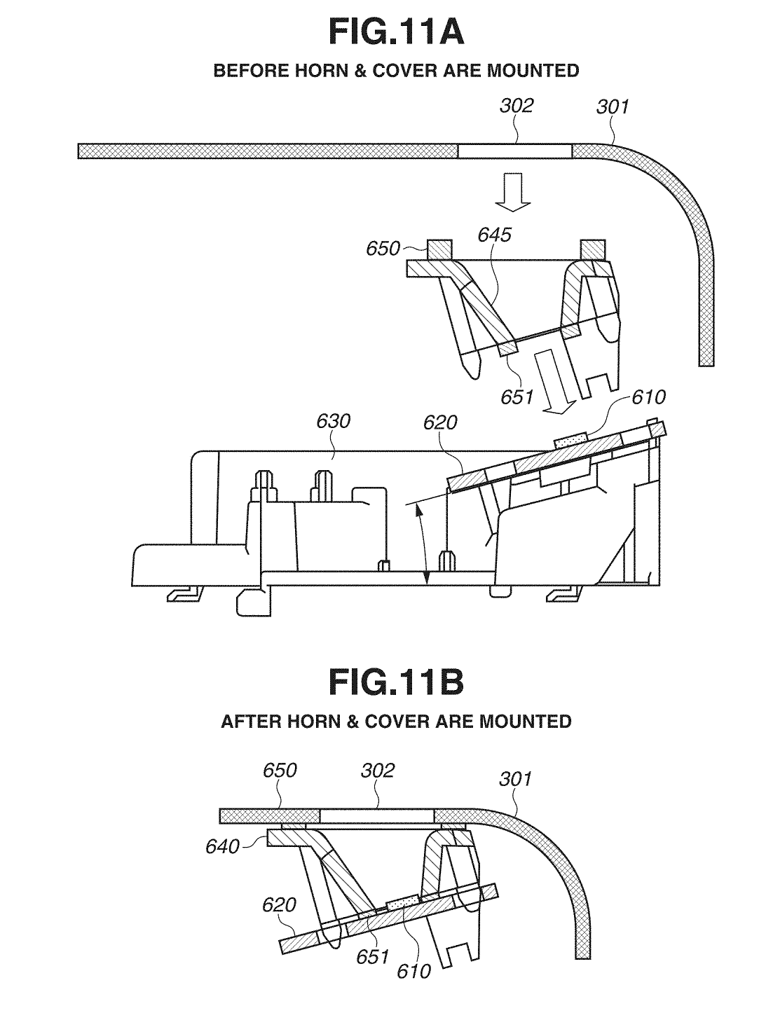

FIGS. 11A and 11B are sectional views of the human sensor unit. FIG. 11A is an exploded sectional view of the human sensor unit. FIG. 11B is a sectional view of the human sensor unit.

As illustrated in FIG. 11A, the buffer member 651 is not compressed before the horn 640 is fixed to the pedestal 630. Also as illustrated in FIG. 11A, the buffer member 650 is not compressed before the cover member 301 is attached in front of the horn 640.

When the horn 640 is fixed to the pedestal 630, the buffer member 651 is compressed and the gap between the substrate 620 and the horn 640 is closed up. As a result, an ultrasonic wave output from the ultrasonic sensor 610 is inhibited from leaking out from the gap between the substrate 620 and the horn 640. Furthermore, the substrate 620 comes into contact with the horn 640 via the buffer member 651 and thus, vibration of the ultrasonic sensor 610 can be inhibited from propagating from the substrate 620 to the horn 640.

Furthermore, if the cover member 301 is attached, the buffer member 650 is compressed and the gap between the cover member 301 and the horn 640 is closed up. Accordingly, an ultrasonic wave output from the ultrasonic sensor 610 is inhibited from leaking out from the gap between the cover member 301 and the horn 640. Furthermore, the horn 640 comes into contact with the cover member 301 via the buffer member 650 and thus, vibration of the ultrasonic sensor 610 can be inhibited from propagating from the horn 640 to the cover member 301.

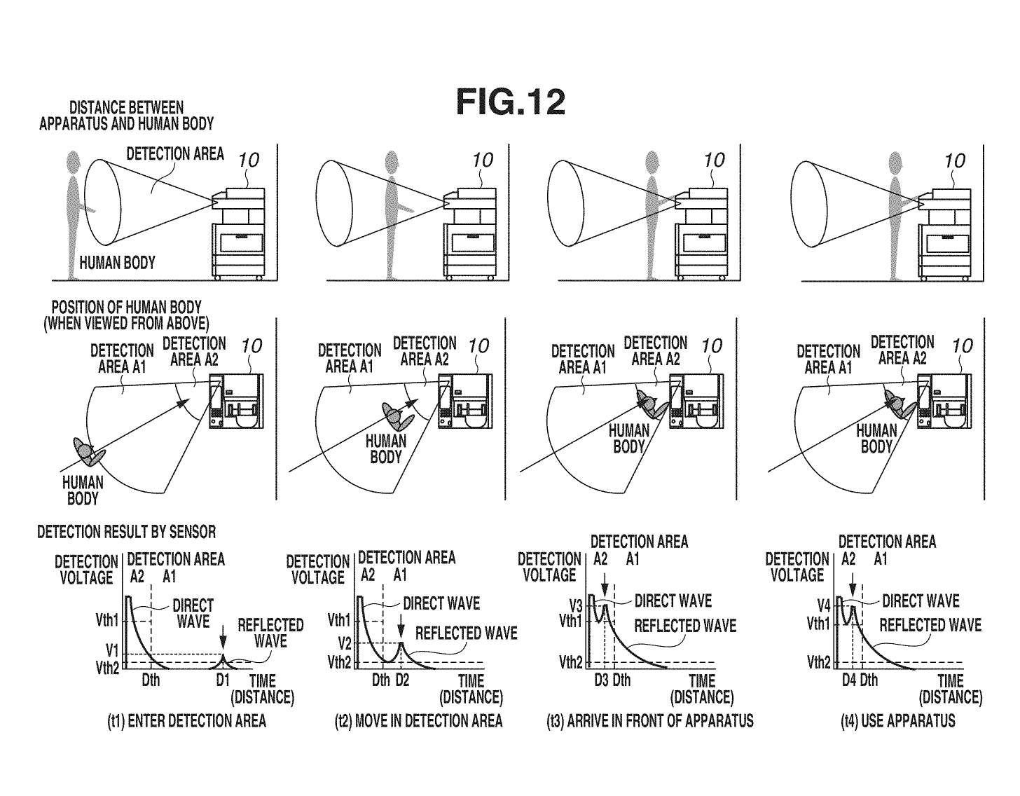

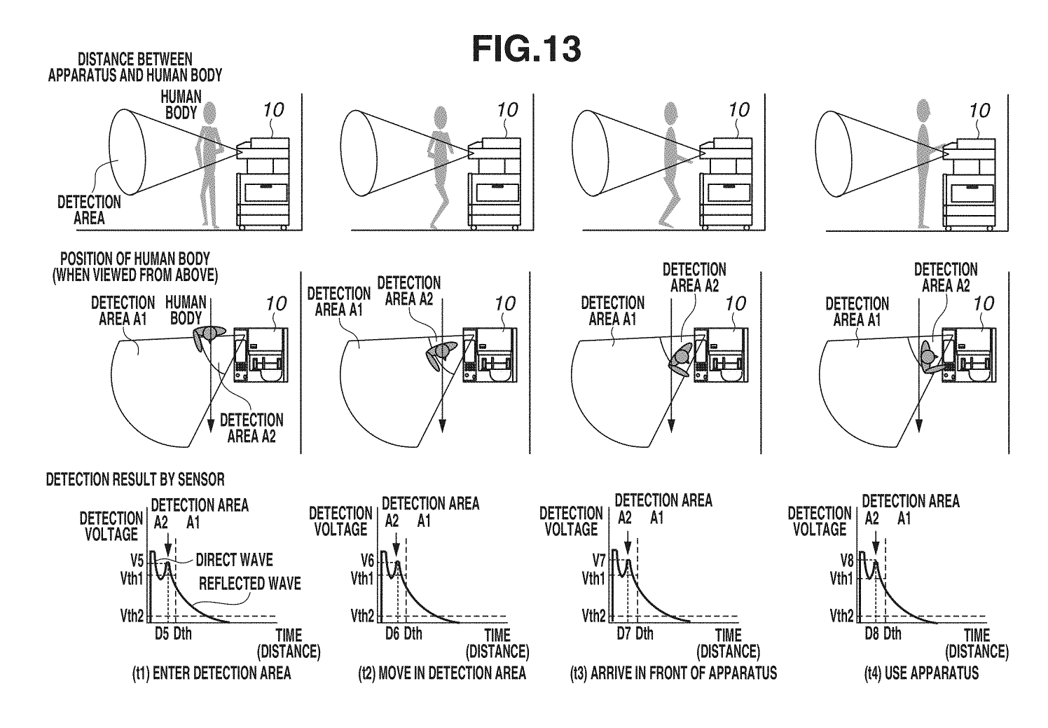

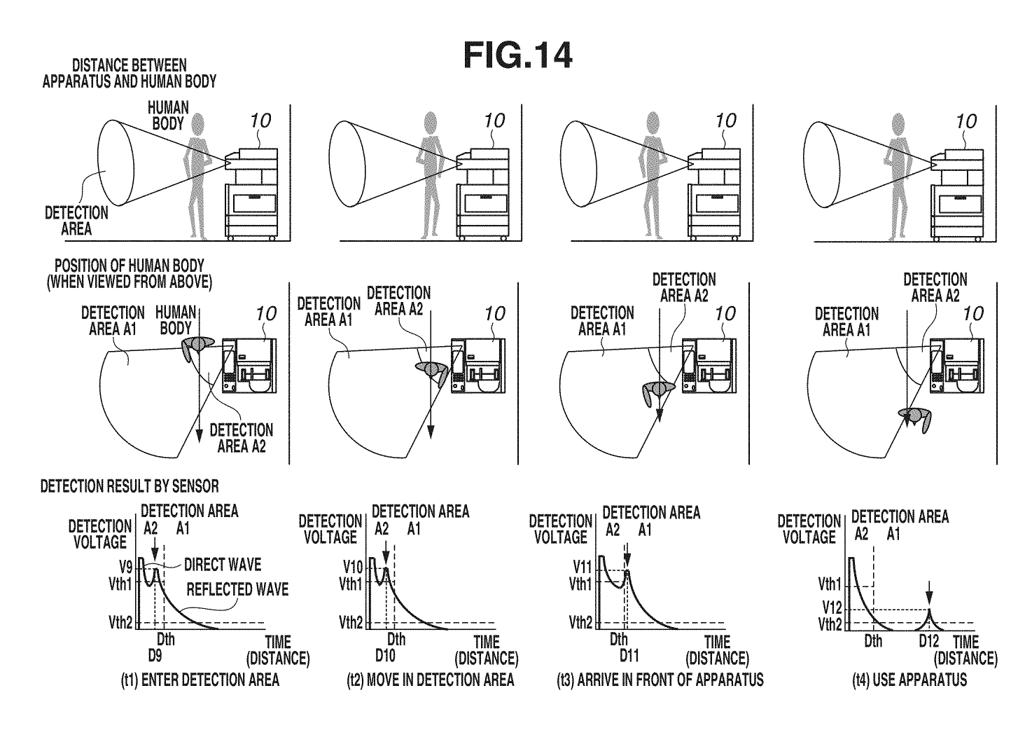

FIG. 12 is a diagram illustrating a case where a user approaches the MFP from the front thereof. Diagrams when the positional relationship between the MFP 10 and the user is viewed from the side are illustrated in the top section of FIG. 12. Diagrams when the positional relationship between the MFP 10 and the user is viewed from above are illustrated in the middle section of FIG. 12. Detection results by an ultrasonic sensor are illustrated in the bottom section of FIG. 12. In FIG. 12, states at t1 to t4 are illustrated in order from left. This also applies to FIGS. 13 and 14 described below.

As illustrated in the bottom section of FIG. 12, the waveform of detection results by the ultrasonic sensor 610 includes a waveform accompanying oscillation of an ultrasonic wave and a waveform of a reflected wave. The ultrasonic sensor 610 in the present example embodiment outputs an ultrasonic wave by oscillating the ultrasonic sensor 610 for a predetermined time. Thus, in an initial stage of detection results by the ultrasonic sensor 610, an influence of oscillation for the output of an ultrasonic wave arises. Then, the ultrasonic sensor 610 receives a reflected wave of the ultrasonic wave reflected by a person or an object. The ultrasonic sensor 610 outputs sound pressure intensity of a reflected wave as a voltage value (this voltage value is denoted as a detection amplitude V). If an output unit that outputs an ultrasonic wave is configured separately from a receiving unit that receives the ultrasonic wave, a waveform accompanying the above oscillation does not appear, but the ultrasonic wave output from the output unit is directly received by the receiving unit and thus, a waveform similar to the waveform illustrated in FIG. 12 is obtained.

FIG. 12 (t1) illustrates a state in which the user enters a place that can be detected by the ultrasonic sensor 610. As a detection result by the ultrasonic sensor 610, a detection amplitude V1 larger than a preset threshold amplitude Vth2 is generated when time D1 passes after the ultrasonic wave is oscillated. The time D1 is the time needed for the ultrasonic wave to return after the ultrasonic wave is output and reflected by the user and thus corresponds to the distance between the MFP 10 and the user. In the description that follows, the time D1 (the time between the output of a direct wave and detection of a reflected wave) is handled as a distance D1. In the present example embodiment, it is determined that a person is present in a detection area A1 based on detection of the detection amplitude V larger than the threshold amplitude Vth2 at a distance farther than a predetermined distance Dth (hereinafter, called a threshold distance Dth). Also, it is determined that a person is present in a detection area A2 based on detection of the detection amplitude V larger than a threshold amplitude Vth1 (>Vth2) at a distance shorter than the threshold distance Dth. When a user is present in a position far from the ultrasonic sensor 610, reflected waves from afar diffuse and all reflected waves cannot be received and thus, the detection amplitude V attenuates and becomes smaller. In FIG. 12 (t1), the detection amplitude V exceeding the threshold amplitude Vth1 is not generated at a distance shorter than the threshold distance Dth and thus, the MFP 10 maintains the sleep mode.

FIG. 12 (t2) illustrates a state in which the user moves toward the detection area A2. The user has not yet entered the detection area A2.

As a detection result by the ultrasonic sensor 610, a detection amplitude V2 larger than the threshold amplitude Vth2 is output at a distance D2 shorter than the distance D1 and farther than the threshold distance Dth. The detection amplitude V2 is larger than the detection amplitude V1. In FIG. 12 (t2), the detection amplitude V exceeding the threshold amplitude Vth1 is not generated at a distance shorter than the threshold distance Dth and thus, the MFP 10 maintains the sleep mode.

FIG. 12 (t3) illustrates a state in which the user has entered the detection area A2. As a detection result by the ultrasonic sensor 610, a detection amplitude V3 larger than the threshold amplitude Vth1 is output at a distance D3 shorter than the threshold distance Dth. In FIG. 12 (t3), the detection amplitude V exceeding the threshold amplitude Vth1 is generated at a distance shorter than the threshold distance Dth, but the detection amplitude V exceeding the threshold amplitude Vth1 has not been generated continuously for a predetermined time at a distance shorter than the threshold distance Dth and thus, the MFP 10 maintains the sleep mode.

FIG. 12 (t4) illustrates a state in which the user remains in the detection area A2. As a detection result by the ultrasonic sensor 610, a detection amplitude V4 larger than the threshold amplitude Vth1 is output at a distance D4 shorter than the threshold distance Dth. If the detection amplitude V exceeding the threshold amplitude Vth1 is generated continuously for a predetermined time at a distance shorter than the threshold distance Dth, the MFP 10 cancels the sleep mode to transfer to the standby mode. The predetermined time is, for example, 300 ms.

FIG. 13 is a diagram illustrating a case where the user approaches the MFP from the side thereof.

FIG. 13 (t1) illustrates a state in which the user enters a place that can be detected by the ultrasonic sensor 610. As a detection result by the ultrasonic sensor 610, a detection amplitude V5 larger than the threshold amplitude Vth1 is output at a distance D5 shorter than the threshold distance Dth. At this point, the detection amplitude V exceeding the threshold amplitude Vth1 has not been generated continuously for a predetermined time (for example, 300 ms) at a distance shorter than the threshold distance Dth and thus, the MFP 10 maintains the sleep mode.

FIG. 13 (t2) illustrates a state in which the user moves in the detection area A2. As a detection result by the ultrasonic sensor 610, a detection amplitude V6 larger than the threshold amplitude Vth1 is output at a distance D6 shorter than the threshold distance Dth. Also at this point, the detection amplitude V exceeding the threshold amplitude Vth1 has not been generated continuously for a predetermined time (for example, 300 ms) at a distance shorter than the threshold distance Dth and thus, the MFP 10 maintains the sleep mode.

FIG. 13 (t3) illustrates a state in which the user arrives in front of the MFP 10. As a detection result by the ultrasonic sensor 610, a detection amplitude V7 larger than the threshold amplitude Vth1 is output at a distance D7 shorter than the threshold distance Dth. Also at this point, the detection amplitude V exceeding the threshold amplitude Vth1 has not been generated continuously for a predetermined time (for example, 300 ms) at a distance shorter than the threshold distance Dth and thus, the MFP 10 maintains the sleep mode.

FIG. 13 (t4) illustrates a state in which the user remains in front of the MFP 10. As a detection result by the ultrasonic sensor 610, a detection amplitude V8 larger than the threshold amplitude Vth1 is output at a distance D8 shorter than the threshold distance Dth. At this point, the detection amplitude V exceeding the threshold amplitude Vth1 has been generated continuously for a predetermined time (for example, 300 ms) at a distance shorter than the threshold distance Dth and thus, the MFP 10 cancels the sleep mode to return to the standby mode.

FIG. 14 is a diagram illustrating a case where a passerby passes in front of the MFP.

FIG. 14 (t1) illustrates a state in which the passerby enters the range of distance that can be detected by the ultrasonic sensor 610. As a detection result by the ultrasonic sensor 610, a detection amplitude V9 larger than the threshold amplitude Vth1 is output at a distance D9 shorter than the threshold distance Dth. At this point, the detection amplitude V exceeding the threshold amplitude Vth1 has not been generated continuously for a predetermined time (for example, 300 ms) at a distance shorter than the threshold distance Dth and thus, the MFP 10 maintains the sleep mode.

FIG. 14 (t2) illustrates a state in which the passerby moves in the detection area A2. As a detection result by the ultrasonic sensor 610, a detection amplitude V10 larger than the threshold amplitude Vth1 is output at a distance D10 shorter than the threshold distance Dth. Also at this point, the detection amplitude V exceeding the threshold amplitude Vth1 has not been generated continuously for a predetermined time (for example, 300 ms) at a distance shorter than the threshold distance Dth and thus, the MFP 10 maintains the sleep mode.

FIG. 14 (t3) illustrates a state in which the passerby moves out of the detection area A2. As a detection result by the ultrasonic sensor 610, a detection amplitude V11 larger than the threshold amplitude Vth1 is output at a distance D11 longer than the threshold distance Dth. The detection amplitude V11 larger than the threshold amplitude Vth1 is not generated at a distance shorter than the threshold distance Dth and thus, the MFP 10 maintains the sleep mode.

FIG. 14 (t4) illustrates a state in which the passerby moves out of the detection area A1. As a detection result by the ultrasonic sensor 610, a detection amplitude V12 smaller than the threshold amplitude Vth1 is output at a distance D12 longer than the threshold distance Dth. The detection amplitude V larger than the threshold amplitude Vth1 is not generated at a distance shorter than the threshold distance Dth and thus, the MFP 10 maintains the sleep mode. When, like in FIG. 14 (t4), the passerby starts to leave the place where the MFP 10 is used (position in front of the operation unit 500), the detection distance D gradually increases and the detection amplitude V becomes gradually smaller.

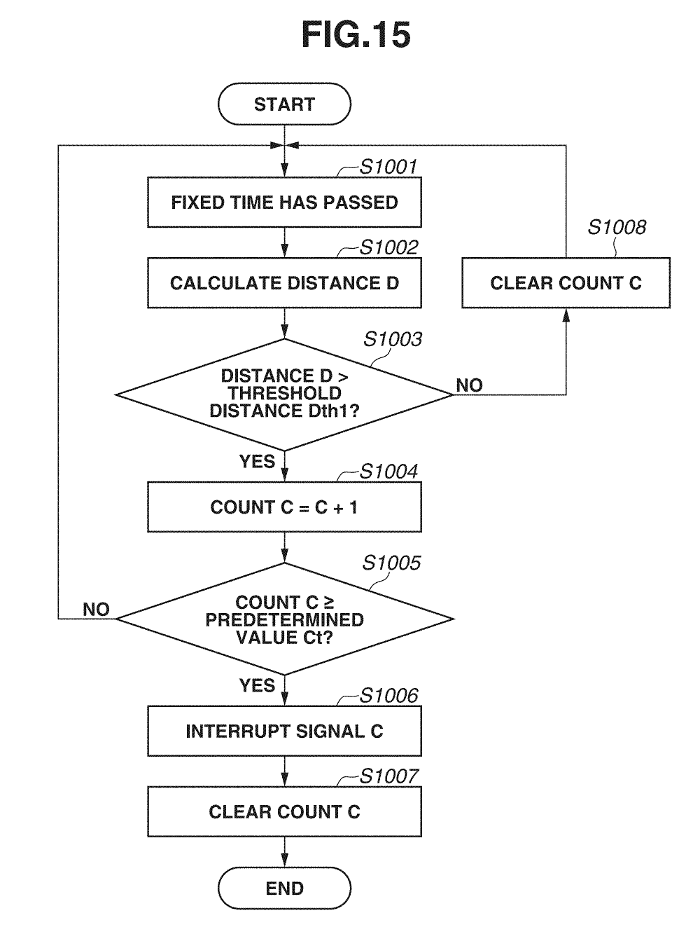

FIG. 15 is a flowchart illustrating a return algorithm based on a detection result by the ultrasonic sensor. The microcomputer 514 of the MFP 10 executes each step in FIG. 15 according to a program.

In step S1001, the microcomputer 514 acquires a detection result by the ultrasonic sensor 610 at fixed intervals (for example, 100 ms). In step S1002, the microcomputer 514 calculates the distance D to the position where the detection amplitude V larger than the detection amplitude Vth1 is generated based on the detection result acquired from the ultrasonic sensor 610. In step S1003, the microcomputer 514 determines whether the calculated distance D is equal to or larger than a preset threshold distance Dth.

If the calculated distance D is determined to be equal to or larger than the preset threshold distance Dth (YES in step S1003), the microcomputer 514 increments a count C in step S1004. Next, in step S1005, the microcomputer 514 determines whether the count C is equal to or larger than a preset predetermined value Ct (for example, Ct=4). If the count C is determined to be equal to or larger than the preset predetermined value Ct (YES in step S1005), the microcomputer 514 outputs an interrupt signal C to the power supply control unit 211 in step S1006. The power supply control unit 211 having received the interrupt signal C returns the MFP 10 from the sleep mode to the standby mode. In step S1007, the microcomputer 514 clears the count C.

If, in step S1003, the calculated distance D is determined to be less than the threshold distance Dth (NO in step S1003), the microcomputer 514 clears the count C in step S1008.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to example embodiments, it is to be understood that the invention is not limited to the disclosed example embodiments. The scope of the following claims is to be accorded the broadest interpretation so as to encompass all such modifications and equivalent structures and functions.

This application claims the benefit of Japanese Patent Application No. 2016-150104, filed Jul. 29, 2016, which is hereby incorporated by reference herein in its entirety.

What is claimed is:

1. An information processing apparatus comprising:
a substrate on which a vibration component that outputs a sound wave through vibration is mounted;
a horn in a tubular shape configured to limit an output direction of the sound wave output from the vibration component; and
a first buffer member provided between a surface of the substrate on a side on which the vibration component is provided and an opening on one side of the horn.

2. The information processing apparatus according to claim 1, wherein the first buffer member is a sponge.

3. The information processing apparatus according to claim 1, further comprising:
a cover member provided on the other side of the horn; and
a second buffer member provided between an opening on the other side of the horn and the cover member.

4. The information processing apparatus according to claim 3, wherein the second buffer member is a sponge.

5. The information processing apparatus according to claim 3, wherein the second buffer member has an annular shape surrounding the opening on the other side of the horn.

6. The information processing apparatus according to claim 1, wherein the first buffer member has an annular shape surrounding the vibration component mounted on the substrate.

7. The information processing apparatus according to claim 1, wherein the vibration component further receives a reflected wave of the sound wave output from the vibration component, the information processing apparatus further comprising a control unit configured to control a power mode of the information processing apparatus based on a detection result of the reflected wave by the vibration component.

8. The information processing apparatus according to claim 1, further comprising a printing unit configured to print an image on a sheet.
